(19) United States
(12) Patent Application Publication
(10) Pub. No.: US 2013/0294291 A1
(43) Pub. Date: Nov. 7, 2013

(54) POLICY CONTROL INTERWORKING

(71) Applicant: Juha Antero Rasanen, Espoo (FI)

(72) Inventor: Juha Antero Rasanen, Espoo (FI)

(73) Assignee: NOKIA SIEMENS NETWORKS OY, Espoo (FI)

(21) Appl. No.: 13/878,322

(22) PCT Filed: Oct. 6, 2010
(86) PCT No.: PCT/EP10/64945

§ 371 Date: Jun. 28, 2013

(51) Int. Cl. H04L 12/14

(52) U.S. Cl. CPC H04L 12/1407
USPC 370/259

(57) ABSTRACT

There are provided measures for policy control interworking, such as for example for policy control interworking between mobile networks and fixed broadband networks, said measures exemplarily comprising exchanging, between a first policy decision point and a second policy decision point, supported policy control properties of a first policy enforcement point under control of the first policy decision point and supported policy control properties of a second policy enforcement point under control of the second policy decision point. An activation of one or more of supported policy control properties is essentially based on a consideration of both supported policy control properties of the first and the second policy enforcement points.

### FIELD OF THE INVENTION

The present invention generally relates to policy control interworking. Specifically, the present invention relates to policy control interworking between mobile networks and fixed broadband networks.

### BACKGROUND OF THE INVENTION

In current and future communication networks and systems, policy control is an essential feature. In general, policy control is a known process in communication networks and systems, whereby usually a policy control entity and/or a policy decision entity indicates to a policy enforcement entity e.g. how to control bearer resources. For example, in an IP-based (IP: Internet Protocol) network environment, such as an IP Connectivity Access Network (IP-CAN), the IP-CAN bearer may be controlled by way of policy control. Policy control may include QoS (quality of service) control, gating control, charging, and the like. Sometimes, policy control is also referred to as policy and charging control.

Currently, each communication network or system, e.g. each standardization body, provides for individual policy control mechanisms and facilities so that there are various policy control mechanisms and facilities for the various existing communication networks or systems. This is a problem in the merging and/or interworking of different communication networks or systems, while such merging and/or interworking is a growing demand in today's communication technology.

For the purpose of the subsequent description, 3GPP and BBF are adopted as non-limiting examples of standardization bodies and associated networks/systems, while any conceivable combination of different standardization bodies and associated networks/systems is equally applicable, in particular any combination of (standards of) mobile networks/systems and (standards of) (fixed) broadband networks/systems.

For example, the 3GPP (Third Generation Partnership Project) has its standardized policy control mechanisms and facilities specifically dedicated for mobile networks, and the BBF (Broadband Forum) has its standardized policy control mechanisms and facilities specifically dedicated for fixed broadband networks. So, for a merging and/or interworking of 3GPP-based (mobile) networks and BBF-based (fixed broadband) networks, certain mechanisms for policy (and charging) control interworking are required, which are currently not available.

The 3GPP is currently working on issues regarding the interworking between (3GPP) mobile networks and (BBF) fixed broadband networks. As indicated above, policy (and charging) control is an important and integral part of such interworking.

In this regard, a currently developed “Building Block 1” contains various scenarios where a terminal or user equipment (UE) connected to a BBF access uses services that are offered by a 3GPP network, i.e. the user traffic is routed from the BBF access to the 3GPP packet core network (EPC: evolved packet core). In these scenarios, both the BBF and 3GPP networks have their own policy control and enforcement functions on the user plane.

In this regard, a forthcoming “Building Block 3” is assumed to support scenarios where a terminal or user equipment (UE) connected to a 3GPP access uses services that are offered by a BBF network, i.e. the user traffic is routed from the 3GPP access to the BBF packet core network. In these scenarios, both the 3GPP and BBF networks are assumed to have their own policy control and enforcement functions on the user plane.

In view thereof, for both cases (BBF access to 3GPP network and 3GPP access to BBF network), mechanisms for policy (and charging) control interworking are required.

Generally, in the above-outlined scenarios of merged and/or interworking of different (standards of) networks/systems, some actions in the context of policy (and charging) control, like various policy enforcement measures, volume reporting and charging control, may be supported by two different network elements and/or policy enforcement points (PEPs) on the user plane of the same user session. That is, such actions could e.g. be supported by the PEP of the 3GPP access or network as well as the PEP of the BBF network or access. Conventionally, the different PEPs do not know about each other's capabilities in terms of policy (and charging) control. Conventionally, the different policy decision points (PDPs) controlling the different PEPs do not know about the capabilities of the other PEP controlled by the other PDP either. Hence, any interworking of the different PDPs and/or PEPs is at least impaired or even completely impeded.

Moreover, this deficiency is particularly relevant in view of the fact that practically any current or future capability may be supported by either one or both of the different PEPs involved in a user session. Furthermore, this deficiency is also particularly relevant in view of the fact that, in an effort to optimize performance and scalabilty, overlapping capabilities should not be activated in the different PEPs on the same user plane of a user session.

Generally, in the above-outlined scenarios of merged and/or interworking of different (standards of) networks/systems, the different PEPs may be located in different networks being managed by different operators. Further, other accesses in each network may use the same PEP. Accordingly, a loading and/or performance status at the different PEPs (on the user plane of the same user session) may occasionally be very different. This may further at least hamper an efficient interworking of the different PDPs and/or PEPs. This deficiency is particularly relevant for processing intensive activities. Namely, it may be preferable to be able to activate certain processing intensive activities, like shaping or usage monitoring or deep packet inspection, if supported by both PEPs on the user plane, at the one with less loading and/or better performance, when establishing a new user session. Conventionally, such load balancing or load sharing is not possible.

Currently, there are no mechanisms for handling the above-mentioned issues.

In view thereof, there are several drawbacks and problems in conventional techniques for policy (and charging) control in terms of a merging and/or interworking of different (standards of) networks/systems, such as e.g. mobile networks and (fixed) broadband networks. Such drawbacks and problems are to be overcome or at least mitigated for providing an efficient policy control interworking, e.g., in particular, an efficient policy control interworking between mobile networks and (fixed) broadband networks.

Accordingly, there is a demand for mechanisms for policy control interworking, e.g., in particular, an efficient policy control interworking between mobile networks and (fixed) broadband networks.

### SUMMARY OF EMBODIMENTS OF THE INVENTION

The present invention and its embodiments aim at solving the above problems.

The present invention and its embodiments are made to provide for mechanisms for policy control interworking, e.g., in particular, an efficient policy control interworking between mobile networks and (fixed) broadband networks.

According to an exemplary first aspect of the present invention, there is provided a method comprising exchanging, between a first policy decision point and a second policy decision point, supported policy control properties of a first policy enforcement point under control of the first policy decision point and supported policy control properties of a second policy enforcement point under control of the second policy decision point.

According to further developments or modifications thereof, one or more of the following applies:

the method further comprises acquiring the supported policy control properties of the first policy enforcement point,

the acquiring comprises at least one of receiving the supported policy control properties from the first policy enforcement point upon control session establishment between the first policy decision point and the first policy enforcement point, and informing the supported policy control properties upon pre-configuration,

the method further comprises deciding which one or ones of the policy control properties being supported by the first policy enforcement point is or are to be activated at the first policy enforcement point,

the method further comprises deciding, at either one of the first and second policy decision points, which one of the first and second policy enforcement points is to activate the one or ones of the policy control properties being supported by both of the first and second policy enforcement points,

the deciding is based on the supported policy control properties of the first and second policy enforcement points,

the deciding is based on at least one of a pre-arrangement in terms of a user for which policy control is to be applied, and an indication being exchanged between the first and second policy decision points,

the deciding is based on a priority of one of the first and second policy enforcement points, with respect to the other one of the first and second policy enforcement point, for certain one or ones of policy control properties being supported by both of the first and second policy enforcement points, and said priority is pre-configured and/or included in the exchange of policy control properties,

the method further comprises requesting the first policy enforcement point to activate the supported policy control properties decided to be activated at the first policy enforcement point,

the method further comprises forwarding, to the first policy enforcement point, the supported policy control properties of the second policy enforcement point,

the method is operable at the first policy decision point,

the first and second policy decision points communicate with each other via a S9* interface,

the first/second policy decision function and the first/second policy enforcement function communicate with each other via a Gx interface,

the first and second policy decision points and/or the first and second policy enforcement points are in accordance with different standards and/or are located in different networks,

the first policy decision point comprises a 3GPP-based policy decision point and the second policy decision point comprises a BBF-based policy decision point, or vice versa, and/or

the first policy enforcement point comprises a 3GPP-based policy enforcement point, such as a policy and charging enforcement function, and the second policy enforcement point comprises a BBF-based policy enforcement point, such as traffic detection function, or vice versa.

According to an exemplary second aspect of the present invention, there is provided a method comprising receiving, at a first policy enforcement point under control of a first policy decision point, policy control information from the first policy decision point, and activating one or ones of supported policy control properties of the first policy enforcement point in accordance with the received policy control information.

According to further developments or modifications thereof, one or more of the following applies:

the method further comprises sending the supported policy control properties of the first policy enforcement point to the first policy decision point upon control session establishment between the first policy decision point and the first policy enforcement point,

the received policy control information comprises a request for activation and an indication of the one or ones of the supported policy control properties to be activated at the first policy enforcement point,

the received policy control information comprises supported policy control properties of a second policy enforcement point under control of a second policy enforcement function,

the method further comprises deciding which one or ones of the supported policy control properties is or are to be activated at the first policy enforcement point, wherein said activating is based on the supported policy control properties decided to be activated at the first policy enforcement point,

the deciding is based on a priority of the first policy enforcement point, with respect to the second policy enforcement point, for certain one or ones of policy control properties being supported by both of the first and second policy enforcement points, and said priority is pre-configured and/or included in the received policy control information,

the method is operable at the first policy enforcement point,

the first and second policy decision points communicate with each other via a S9* interface,

the first/second policy decision function and the first/second policy enforcement function communicate with each other via a Gx interface,

the first and second policy decision points and/or the first and second policy enforcement points are in accordance with different standards and/or are located in different networks,

the first policy decision point comprises a 3GPP-based policy decision point and the second policy decision point comprises a BBF-based policy decision point, or vice versa, and/or

the first policy enforcement point comprises a 3GPP-based policy enforcement point, such as a policy and charging enforcement function, and the second policy enforcement point comprises a BBF-based policy enforcement point, such as traffic detection function, or vice versa.

According to an exemplary third aspect of the present invention, there is provided an apparatus comprising a processor and a transceiver configured to exchange, between a first policy decision point and a second policy decision point, supported policy control properties of a first policy enforcement point under control of the first policy decision point and supported policy control properties of a second policy enforcement point under control of the second policy decision point.

According to further developments or modifications thereof, one or more of the following applies:

the processor and the transceiver are further configured to acquire the supported policy control properties of the first policy enforcement point,

the acquiring comprises at least one of receiving the supported policy control properties from the first policy enforcement point upon control session establishment between the first policy decision point and the first policy enforcement point, and informing the supported policy control properties upon pre-configuration,

the processor is further configured to decide one or ones of the policy control properties being supported by the first policy enforcement point is or are to be activated at the first policy enforcement point,

the processor is further configured to decide, at either one of the first and second policy decision points, which one of the first and second policy enforcement points is to activate the one or ones of the policy control properties being supported by both of the first and second policy enforcement points,

the processor is configured to decide based on the supported policy control properties of the first and second policy enforcement points,

the processor is further configured to decide based on at least one of a pre-arrangement in terms of a user for which policy control is to be applied, and an indication being exchanged between the first and second policy decision points,

the processor is further configured to decide based on a priority of one of the first and second policy enforcement points, with respect to the other one of the first and second policy enforcement point, for certain one or ones of policy control properties being supported by both of the first and second policy enforcement points, and said priority is pre-configured and/or included in the exchange of policy control properties,

the processor and the transceiver are further configured to request the first policy enforcement point to activate the supported policy control properties decided to be activated at the first policy enforcement point,

the processor and the transceiver are further configured to forward, to the first policy enforcement point, the supported policy control properties of the second policy enforcement point,

the apparatus is operable as or at the first policy decision point,

the first and second policy decision points communicate with each other via a S9* interface,—the first/second policy decision function and the first/second policy enforcement function communicate with each other via a Gx interface,

the first and second policy decision points and/or the first and second policy enforcement points are in accordance with different standards and/or are located in different networks,

the first policy decision point comprises a 3GPP-based policy decision point and the second policy decision point comprises a BBF-based policy decision point, or vice versa, and/or

the first policy enforcement point comprises a 3GPP-based policy enforcement point, such as a policy and charging enforcement function, and the second policy enforcement point comprises a BBF-based policy enforcement point, such as traffic detection function, or vice versa.

According to an exemplary fourth aspect of the present invention, there is provided an apparatus comprising a transceiver configured to receive, at a first policy enforcement point under control of a first policy decision point, policy control information from the first policy decision point, and a processor configured to activate one or ones of supported policy control properties of the first policy enforcement point in accordance with the received policy control information.

According to further developments or modifications thereof, one or more of the following applies:

the transceiver is further configured to send the supported policy control properties of the first policy enforcement point to the first policy decision point upon control session establishment between the first policy decision point and the first policy enforcement point,

the received policy control information comprises a request for activation and an indication of the one or ones of the supported policy control properties to be activated at the first policy enforcement point,

the received policy control information comprises supported policy control properties of a second policy enforcement point under control of a second policy enforcement function,

the processor is further configured to decide which one or ones of the supported policy control properties is or are to be activated at the first policy enforcement point, wherein the processor is configured to activate based on the supported policy control properties decided to be activated at the first policy enforcement point,

the processor is configured to decide based on a priority of the first policy enforcement point, with respect to the second policy enforcement point, for certain one or ones of policy control properties being supported by both of the first and second policy enforcement points, and said priority is pre-configured and/or included in the received policy control information,

the apparatus is operable as or at the first policy enforcement point,

the first and second policy decision points communicate with each other via a S9* interface,

the first/second policy decision function and the first/second policy enforcement function communicate with each other via a Gx interface,

the first and second policy decision points and/or the first and second policy enforcement points are in accordance with different standards and/or are located in different networks,

the first policy decision point comprises a 3GPP-based policy decision point and the second policy decision point comprises a BBF-based policy decision point, or vice versa, and/or

the first policy enforcement point comprises a 3GPP-based policy enforcement point, such as a policy and charging enforcement function, and the second policy enforcement point comprises a BBF-based policy enforcement point, such as traffic detection function, or vice versa.

According to an exemplary fifth aspect of the present invention, there is provided a computer program product including a program comprising software code portions being arranged, when run on a processor of an apparatus (such as e.g. according to the above third aspect and/or developments or modifications thereof), to perform the method according to the above first aspect and/or developments or modifications thereof).

According to an exemplary sixth aspect of the present invention, there is provided a computer program product including a program comprising software code portions being arranged, when run on a processor of an apparatus (such as e.g. according to the above fourth aspect and/or developments or modifications thereof), to perform the method according to the above second aspect and/or developments or modifications thereof).

According to further developments or modifications of the present invention, the computer program product according to the fifth and/or sixth aspect comprises a computer-readable medium on which the software code portions are stored, and/or the program is directly loadable into a memory of the processor.

According to any one of the exemplary aspects and/or developments or modifications thereof, as outlined above, the supported policy control properties may comprise at least one of

policy control-related capabilities, such as policy enforcement capabilities and/or volume reporting capabilities and/or charging control capabilities,

status-related information, such as loading status and/or performance status,

preferences of activation of supported policy control properties, and

non-/support and/or extent of non-/support of policy control properties by the respective policy enforcement point and/or another entity.

By way of exemplary embodiments of the present invention, there are provided mechanisms for policy control interworking, e.g., in particular, an efficient policy control interworking between mobile networks and (fixed) broadband networks. Such mechanisms according to exemplary embodiments of the present invention may be particularly applicable in the context of 3GPP-based mobile networks and BBF-based (fixed) broadband networks.

### BRIEF DESCRIPTION OF THE DRAWINGS

In the following, the present invention will be described in greater detail by way of non-limiting examples with reference to the accompanying drawings, in which

FIG. 1 shows a schematic illustration of an exemplary network architecture in which exemplary embodiments of the present invention are applicable,

FIG. 2 shows a signaling diagram illustrating an exemplary procedure according to exemplary embodiments of the present invention,

FIG. 3 shows a signaling diagram illustrating another exemplary procedure according to exemplary embodiments of the present invention, and

FIG. 4 shows a block diagram illustrating exemplary devices according to exemplary embodiments of the present invention.

### DETAILED DESCRIPTION OF EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

Generally, the present invention and its embodiments relate to policy control interworking in different (standards of) networks/systems.

In particular, the present invention and its embodiments are mainly described in relation to 3GPP and/or BBF specifications being used as non-limiting examples for certain exemplary network configurations and deployments. In particular, 3GPP and/or BBF policy control entities, such as policy decision entities and policy enforcement entities, are used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

While the present invention and its embodiments are described with respect to policy control interworking between 3GPP and BBF networks/systems, the problems addressed may also be identified in other configurations or deployments (in particular, policy control interworking between other networks/system), and the present invention and its embodiments are equally applicable is such other configurations or deployments (in particular, policy control interworking between other networks/system). For example, the present invention and its embodiments are equally applicable to all cases of different (standards of) networks/systems having their own policy control mechanisms and facilities.

Embodiment of the present invention, as outlined below, may be applicable in any policy control environment, i.e. in corresponding policy control entities. For example, embodiment of the present invention may be applicable in policy servers, flexi network gateways (NG), other gateways supporting policy enforcement, policy control functions such as a broadband policy control function (BPCF), broadband network gateways such as a broadband network gateway (BNG), and the like.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

In the following, exemplary embodiments of the present invention are described with reference to methods, procedures and functions.

Generally, according to exemplary embodiments of the present invention, policy control interworking is based on an interworking between different policy decision points in terms of an exchange and/or negotiation of relevant information, thereby enabling that the different policy enforcement points under control of the respective policy decision points perform corresponding actions of policy (and charging) control in an efficient and effective manner. Namely, the above-mentioned issues regarding drawbacks and problems of conventional policy control may thereby be handled in a proper manner.

Stated in other words, exemplary embodiments of the present invention provide for mechanisms for negotiating and/or agreeing on policy enforcement action(s) to be applied/activated (wherein hereinafter an application/activation may also refer to a deactivation) in each policy enforcement point.

For the purpose of the subsequent description, specific examples of such relevant information in this regard are used for illustrative purposes only. Yet, it is noted that these specific examples of such relevant information are not limiting in any way, since any information related with policy control may be used, as long as being applicable or even valuable in/for the above-mentioned issues regarding drawbacks and problems of conventional policy control.

According to exemplary embodiments of the present invention, such relevant information, which hereinafter are mostly referred to as policy control properties, may e.g. comprise

policy control-related capabilities (hereinafter also referred to as “policy capabilities” or just as “capabilities”), such as policy enforcement capabilities and/or volume reporting capabilities and/or charging control capabilities, and/or

status-related information (hereinafter also referred to as “status” and/or “load”), such as loading status and/or performance status and/or (temporary) inactivity/unavailability status, and/or

preferences of activation of supported policy control properties (which may be regarded as a sub-feature of the above-mentioned policy control-related capabilities and/or status-related information), and/or

non-/support and/or extent of non-/support of policy control properties by the respective policy enforcement point and/or another entity (which may be regarded as a sub-feature of the above-mentioned policy control-related capabilities and/or status-related information).

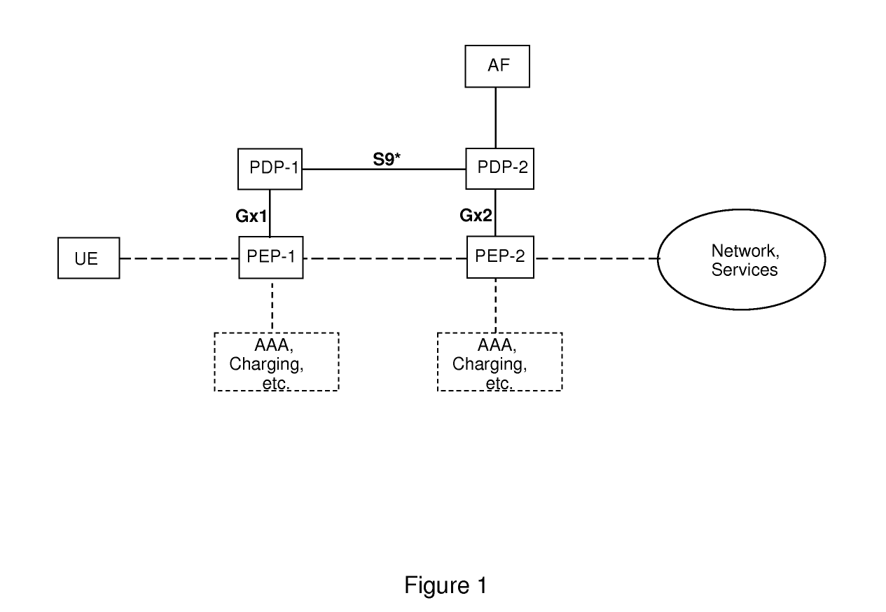

FIG. 1 shows a schematic illustration of an exemplary network architecture in which exemplary embodiments of the present invention are applicable. In particular, FIG. 1 an operating environment with two separate policy decision functions (PDP-1 and PDP-2) and two separate policy enforcement functions (PEP-1 and PEP-2) in the user plane of the same user session (which is depicted by dashed lines). Both policy enforcement functions (PEP-1 and PEP-2) may provide for their own AAA (authorization, authentication, accounting), charging and other services, and the policy decision function (PDP-2) at the side of the accessed network may be connected to an application function (AF).

In the exemplary network architecture shown in FIG. 1, PEP-1 and PDP-1 may be BBF-based policy control entities, and PEP-2 and PDP-2 may be 3GPP-based policy control entities (assuming the scenarios of “Building Block 1” described above). Similarly, in the exemplary network architecture shown in FIG. 1, PEP-1 and PDP-1 may be 3GG-based policy control entities, and PEP-2 and PDP-2 may be BBF-based policy control entities (assuming the scenarios of “Building Block 3” described above). In any case, the respective PDPs and PEPs may be mutually connected via a Gx interface, and the different PDPs may be mutually connected via a S9* interface.

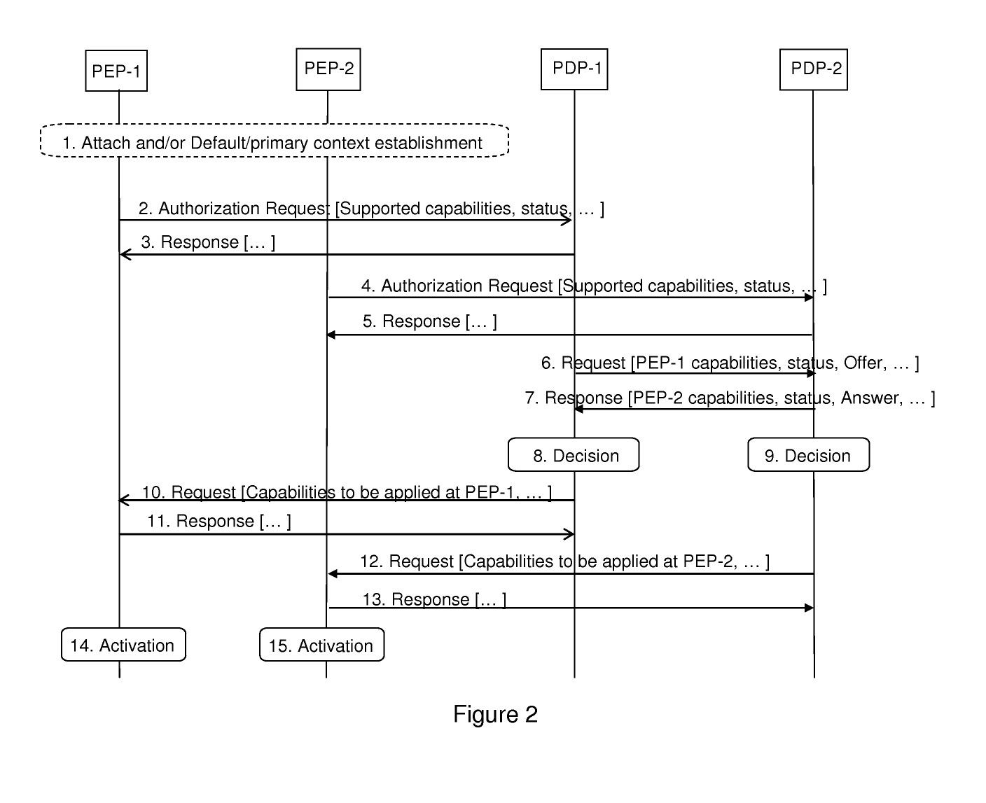

FIG. 2 shows a signaling diagram illustrating an exemplary procedure according to exemplary embodiments of the present invention, which exemplary procedure is based on the network architecture according to FIG. 1.

According to exemplary embodiments of the present invention, each policy decision point acquires policy control properties (including e.g. policy capabilities and/or status and/or load) of its controlled policy enforcement point.

In this regard, as shown in FIG. 2, each PEP may indicate its policy control properties, such as policy enforcement capabilities, volume reporting capabilities, charging control capabilities, etc. and possible loading/performance status, to its controlling PDP. This is illustrated as messages 2 and 3 for PEP-1/PDP-1, and as messages 4 and 5 for PEP-2/PDP-2.

In the exemplary procedure of FIG. 2, such indications are performed when the control session is established between the respective PEP and the respective PDP. Typically, this happens when a terminal or user equipment attaches to the network and the default/primary context is established between the terminal or user equipment and the network. This is indicated as operation 1.

Alternatively, each PDP may know, for example, the capabilities of its controlled PEP in its network, e.g. by (pre-)configuration. In such case, only current (e.g. real-time) values such as the loading/performance status needs to be indicated by the respective PEP or acquired by the respective PDP (e.g. in messages 2 and/or 4).

In the exemplary procedure of FIG. 2, such indications may be performed in the context of an authorization pull procedure by the respective PEP. That is, according to FIG. 2, each PEP may “pull” an authorization from its controlling PDP (by sending an authorization request message) and send, for example, its capabilities and status in the request message.

Alternatively, such indications may be performed in the context of an authorization push procedure by the respective PDP. That is, each PDP may “push” an authorization to its controlled PEP (by sending an authorization request message), and each PEP—upon receipt of the request message—may send, for example, its capabilities and status to its controlling PDP in a response message.

According to exemplary embodiments of the present invention, the different policy decision points exchange the policy control properties (including e.g. policy capabilities and/or status and/or load) of their controlled policy enforcement points, respectively.

In this regard, as shown in FIG. 2, the PDP-1 sends or indicates the policy control properties in the form of, for example, the capabilities and, possibly, the loading/performance status of its controlled PEP-1 to the PDP-2. For example, such indication may also comprise a possible offer regarding what the PEP-1 is preferred to apply. This is illustrated as message 6. Typically, at this phase, the control session is established between the PDP-1 and the PDP-2.

Further, as shown in FIG. 2, the PDP-2 responds by sending or indicating the policy control properties in the form of, for example, the capabilities and, possibly, the loading/performance status of its controlled PEP-2 to the PDP-1. For example, such indication may also comprise a possible offer (or answer) regarding what the PEP-2 is preferred to apply. This is illustrated as message 7.

If, for example, the PDP-2 has not yet received the information from the PEP-2 (i.e. message 4), when receiving the indication from the PDP-1 (i.e. message 6), the PDP-2 may acknowledge receipt of the request and may send the PEP-2-related information to the PDP-1 in a separate request message when available.

In the exemplary procedure of FIG. 2, decisions of policy control are made by policy decision point, i.e. PDP-1 and/or PDP-2.

According to exemplary embodiments of the present invention, it may be decided at each PDP which one or ones of the policy control properties (including e.g. policy capabilities and/or status and/or load) being supported by its controlled PEP is or are to be activated there. That is, the PDP-1 may make a decision regarding the PEP-1, and the PDP-2 may make a decision regarding the PEP-2. Such decisions may be based on the supported policy control properties of both PEPs, including e.g. its capabilities, status, preferences, and the like.

In the exemplary procedure of FIG. 2, after the negotiation/indication message exchange between the PDPs (i.e. after the messages 6 and 7), each PDP determines which capabilities shall be applied/activated to/for the user session in the PEP under control of the respective PDP.

According to exemplary embodiments of the present invention, it may be decided, at either one of the PDPs, which one of the two PEPs is to activate the one or ones of the policy control properties (including e.g. policy capabilities and/or status and/or load) being supported by both of the PEPs. That is, PDP-1 and/or PDP-2 may make a decision regarding the PEP which is to be instructed to make a corresponding activation which could, in fact, be made by both PEPs. Such decision may be based on the supported policy control properties of both PEPs, including e.g. its capabilities, status, preferences, and/or a pre-arrangement in terms of a user for which policy control is to be applied, and/or an indication being exchanged between the first and second policy decision points.

In the exemplary procedure of FIG. 2, if both PEP-1 and PEP-2 support a same capability, either the PDP-2 or the

PDP-1 may determine which one applies/activates this capability that is supported by both of them. This may be an agreement issue (e.g. such that the home/core network PDP makes the decisions) or it may be indicated with a parameter in the message exchange between the PDPs, e.g. by sending capability activation instructions to the other PDP. Such capability activation instructions may be sent either in a separate request/command or in an acknowledgement/reply to a request (such as messages 6 and 7).

The above decisions may be, additionally, based on a priority of one of the two PEPs, with respect to the other PEP, for certain one or ones of policy control properties being supported by both of them. Such priority may be pre-configured and/or included in the exchange of policy control properties (such as in messages 6 and/or 7).

The above-mentioned decision operations are illustrated by operations 8 and 9.

According to exemplary embodiments of the present invention, each policy decision point may instruct and inform its controlled policy enforcement point in accordance with the outcome of the above decisions, respectively. That is, each PDP may request its controlled PEP to perform an activation according to the respective decision.

In the exemplary procedure of FIG. 2, PDP-1 may send a request message with corresponding parameters indicating the capabilities to be activated there to its controlled PEP-1 (which may be referred to as policy control information), and PDP-2 may send a request message with corresponding parameters indicating the capabilities to be activated there to its controlled PEP-2 (which may be referred to as policy control information). This is illustrated as messages 10 and 11 for PEP-1/PDP-1, and as messages 12 and 13 for PEP-2/PDP-2.

According to exemplary embodiments of the present invention, each policy enforcement point may make corresponding activations in accordance with the request or instruction and associated indications from its controlling policy decision point.

In the exemplary procedure of FIG. 2, PEP-1 may activate or apply the capabilities indicated in message 10, and PEP-2 may activate or apply the capabilities indicated in message 12. These activation operations are illustrated by operations 14 and 15.

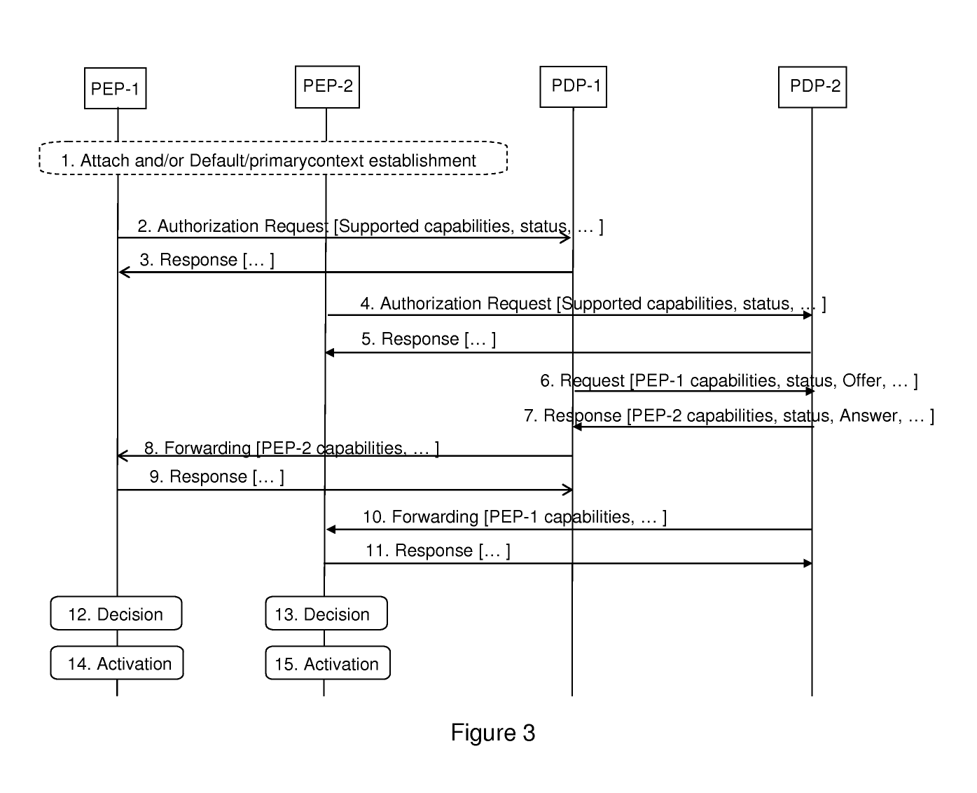

FIG. 3 shows a signaling diagram illustrating another exemplary procedure according to exemplary embodiments of the present invention, which exemplary procedure is based on the network architecture according to FIG. 1.

According to exemplary embodiments of the present invention, each policy decision point acquires policy control properties (including e.g. policy capabilities and/or status and/or load) of its controlled policy enforcement point.

In this regard, operations and messages 1 through 7 according to FIG. 3 basically correspond to those according to FIG. 2, and reference is made to the above description thereof.

In the exemplary procedure of FIG. 3, decisions of policy control are made by policy enforcement point, i.e. PEP-1 and/or PEP-2.

According to exemplary embodiments of the present invention, each policy decision point forwards the policy control properties (including e.g. policy capabilities and/or status and/or load) of the other policy enforcement point, i.e. the policy enforcement point under control of the other policy decision point, to its controlled policy enforcement point. That is, the policy control properties obtained in the exchange of messages 6 and 7 are forwarded to the corresponding policy enforcement points, respectively.

In the exemplary procedure of FIG. 3, the PDP-2 may forward, for example, the capabilities and status of the PEP-1 to its controlled PEP-2 (which may be referred to as policy control information), and the PDP-1 may forward, for example, the capabilities and status of the PEP-2 to its controlled PEP-1 (which may be referred to as policy control information). This is illustrated as messages 8 and 9 for PEP-1/PDP-1, and as messages 10 and 11 for PEP-2/PDP-2.

According to exemplary embodiments of the present invention, it may be decided at each policy enforcement point which one or ones of the supported policy control properties (including e.g. policy capabilities and/or status and/or load) of this policy enforcement point is or are to be activated there. Further, according to exemplary embodiments of the present invention, at each policy enforcement point, the policy control properties thus decided to be activated may be activated there.

In the exemplary procedure of FIG. 3, the PEP-1 may determine which capabilities shall be applied/activated to/for the user session in the PEP-1, and the PEP-2 may determine which capabilities shall be applied/activated to/for the user session in the PEP-2. This is illustrated as operations 12 and 13, respectively.

The above decisions may be, additionally, based on a priority of one of the two PEPs, with respect to the other PEP, for certain one or ones of policy control properties (including e.g. policy capabilities and/or status and/or load) being supported by both of them. Such priority may be pre-configured and/or included in the exchange of policy control properties (such as in messages 6 and/or 7). Namely, either one of the PEPs may have a higher priority for a given capability, or the priority/priorities may be indicated with the capability/capabilities in the negotiation message exchange.

In the exemplary procedure of FIG. 3, on the basis of the above decision, the PEP-1 may activate the capabilities decided to be applied/activated to/for the user session in the PEP-1, and the PEP-2 may activate the capabilities decided to be applied/activated to/for the user session in the PEP-2. This is illustrated as operations 14 and 15, respectively.

Generally, in the exemplary procedures of FIGS. 2 and 3, any communications may be implemented on the basis of currently available mechanisms which are to be enhanced according to exemplary embodiments of the present invention. In particular, currently available “supported features” mechanisms may be utilized according to exemplary embodiments of the present invention. For example, the currently available “supported features” mechanism on/for the Gx interface may be enhanced with new parameters to indicate the policy control properties such as the capabilities and status of PEPs to corresponding PDPs. The S9* interface between 3GPP PDP and BBF PDP may also use the currently available “supported features” mechanism on/for the S9 interface to indicate/negotiate the policy control properties such as the capabilities and status (of PEPs) between the PDPs. Parameters may be added to the Gx protocol to indicate the policy control properties such as the capabilities and status of the BBF PEP to the 3GPP PEP, and/or parameters may be defined in the BBF R/Gx* interface protocol to indicate the policy control properties such as the capabilities and status of the 3GPP PEP to the BBF PEP.

Generally, in the exemplary procedures of FIGS. 2 and 3, the capability negotiation/indication, in particular, the capability exchange, may also indicate that a certain capability is not supported by an entity and should be supported by the other entity, and/or that a certain capability is supported to a certain extent (e.g. certain shaping measures) and the entity having a better support should apply/activate this capability.

Generally, it is noted that the sequence of operations and messages according to FIGS. 2 and 3 are only exemplary and illustrative, and the sequence of certain operations and messages may also be different. For example, in the exemplary procedure of FIG. 2, message pair 4/5 may be simultaneous with or prior to message pair 2/3, message pair 12/13 may be simultaneous with or prior to message pair 10/11, and the decision operations 8/9 as well as the activation operations 14/15 may have any arbitrary sequence. For example, in the exemplary procedure of FIG. 3, message pair 4/5 may be simultaneous with or prior to message pair 2/3, message pair 10/11 may be simultaneous with or prior to message pair 8/9, and the decision operations 12/13 as well as the activation operations 14/15 may have any arbitrary sequence (as long as a decision at one entity is prior to an activation at this entity). Further, it is to be noted that at least some of the response message according to FIGS. 2 and 3 are only exemplary and illustrative, and may be omitted because of being not necessary for the embodiments of the present invention. For example, in the exemplary procedure of FIG. 2, response messages 3, 5, 11 and 13 may be dispensable. For example, in the exemplary procedure of FIG. 3, response messages 3, 5, 9 and 11 may be dispensable.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

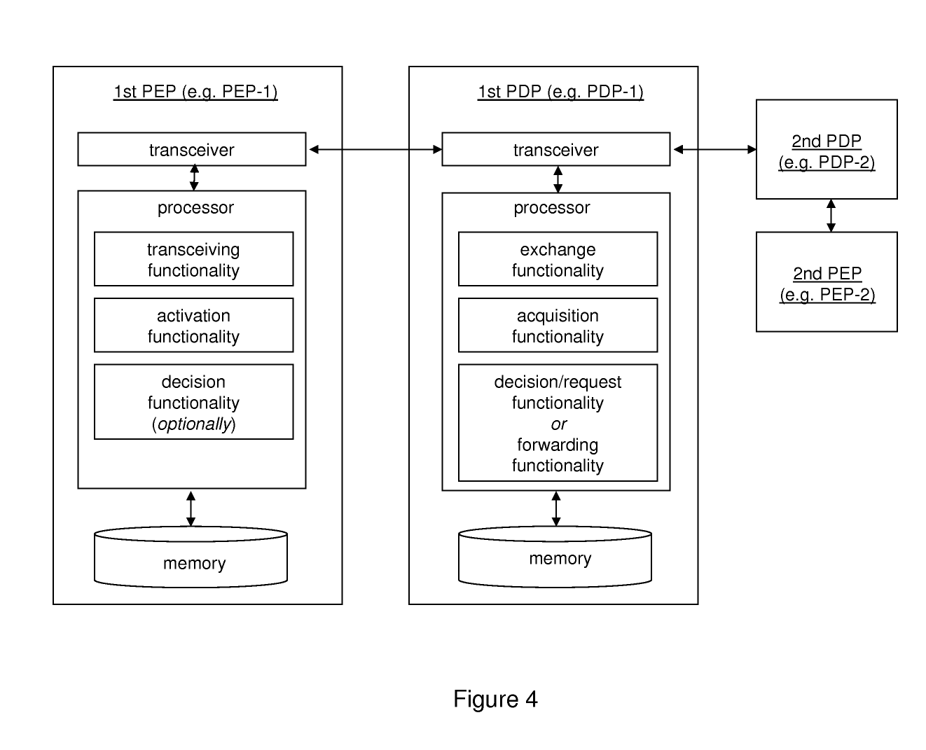

Respective exemplary embodiments of the present invention are described below referring to FIG. 4, while for the sake of brevity reference is made to the detailed description of respective corresponding methods and operations according to FIGS. 2 and 3 above as well as to the detailed description of an underlying network architecture according to FIG. 1 above.

In FIG. 4 below, the solid line blocks are basically configured to perform respective operations as described above. The entirety of solid line blocks are basically configured to perform the methods and operations as described above, respectively. With respect to FIG. 4, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 4, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 4 shows a block diagram illustrating exemplary devices according to exemplary embodiments of the present invention. Any one of the thus depicted devices may be an apparatus according exemplary embodiments of the present invention, and any combination of the thus depicted devices (e.g. a combination of first PDP and first PEP, and of second PDP and second PEP) may be a system according exemplary embodiments of the present invention.

In view of the above, the thus described apparatus on the left side may represent a (part of a) apparatus such as a policy enforcement point, as described above, and the thus described apparatus in the middle may represent a (part of a) apparatus such as a policy decision point, as described above, and the thus described apparatuses on the right side may represent a (part of a) apparatus such as a policy decision point and a (part of a) apparatus such as a policy enforcement point, as described above.

For the exemplary illustration of FIG. 4, it is assumed that PEP-1 represents a first policy enforcement point according to exemplary embodiments of the present invention and that PDP-1 represents a first policy decision point according to exemplary embodiments of the present invention. Equally, while not shown, PEP-2 may represent a first policy enforcement point according to exemplary embodiments of the present invention and that PDP-2 represents a first policy decision point according to exemplary embodiments of the present invention.

Generally, according to exemplary embodiments of the present invention, either one of the first and second policy decision points may be a 3GPP-based policy decision point, and the other one of the first and second policy decision points may be a BBF-based policy decision point.

Accordingly, either one of the first and second policy enforcement points may be a 3GPP-based policy enforcement point (such as e.g. a PCEF (policy and charging enforcement function)), and the other one of the first and second policy enforcement points may be a BBF-based policy enforcement point (such as e.g. a PEP in a BNG (Broadband Network Gateway)).

While details of the first policy decision point and the first policy enforcement point are described below, corresponding descriptions similarly apply to the second policy decision point and the second policy enforcement point, depending on the perspective of consideration.

According to FIG. 4, the apparatus on the left side is an apparatus according to exemplary embodiments of the present invention. This apparatus is configured to perform a procedure as described for any one of PEP-1 and PEP-2 in conjunction with FIG. 2 or FIG. 3. Therefore, while basic functionalities are described hereinafter, reference is made to the above description of FIGS. 2 and 3 for details thereof.

According to FIG. 4, the thus depicted apparatus according to exemplary embodiments of the present invention comprises a processor and a transceiver as well as, optionally, a memory.

The processor may be specifically configured to acquire a location of a terminal with respect to a base station of a serving cell of a cellular communication system, thus representing means for acquiring a terminal location. In other words, the processor may have a corresponding location acquiring functionality.

The transceiver may be specifically configured to receive policy control information from the first policy decision point, thus representing means for receiving policy control information. Such policy control information may comprise a request for activation and an indication of the one or ones of the supported policy control properties (including e.g. policy capabilities and/or status and/or load) to be activated at the first policy enforcement point (according to the exemplary procedure of FIG. 2) or supported policy control properties (including e.g. policy capabilities and/or status and/or load) of the second policy enforcement point under control of the second policy enforcement function (according to the exemplary procedure of FIG. 3).

The transceiver may also be specifically configured to send the supported policy control properties (including e.g. policy capabilities and/or status and/or load) of the first policy enforcement point to the first policy decision point, this representing means for sending supported policy control properties (including e.g. policy capabilities and/or status and/or load). Such sending may, for example, be operable upon control session establishment between the first policy decision point and the first policy enforcement point.

In view of the functionalities of the transceiver, the processor may be specifically configured to send corresponding information/data (after a corresponding processing) and/or receive corresponding information/data (for a corresponding processing) to/from the transceiver, thus representing means for transceiving corresponding information/data. In other words, the processor may have a corresponding transceiving functionality.

The processor may be specifically configured to activate one or ones of supported policy control properties (including e.g. policy capabilities and/or status and/or load) of the first policy enforcement point in accordance with the received policy control information, thus representing means for activating policy control properties (including e.g. policy capabilities and/or status and/or load). In other words, the processor may have a corresponding activation functionality.

The processor may also be specifically configured to decide which one or ones of the supported policy control properties (including e.g. policy capabilities and/or status and/or load) is or are to be activated at the first policy enforcement point (according to the exemplary procedure of FIG. 3), thus representing means for deciding. Such decision may, for example, also be based on a priority of the first policy enforcement point, with respect to the second policy enforcement point, for certain one or ones of policy control properties being supported by both of the first and second policy enforcement points. In other words, the processor may have a corresponding decision functionality (in the exemplary implementation according to FIG. 3). In such case, the processor may be specifically configured to perform any activation based on the supported policy control properties decided to be activated at the first policy enforcement point.

The memory may be specifically configured to store any data required for and/or resulting from the above-described functionalities. For example, the memory may store information regarding supported policy control properties of the first policy enforcement point, received information regarding policy control properties to be activated (according to the exemplary procedure of FIG. 2), received information regarding supported policy control properties of the second policy enforcement point (according to the exemplary procedure of FIG. 3), and the like.

According to FIG. 4, the apparatus in the middle is an apparatus according to exemplary embodiments of the present invention. This apparatus is configured to perform a procedure as described for any one of PDP-1 and PDP-2 in conjunction with FIG. 2 or FIG. 3. Therefore, while basic functionalities are described hereinafter, reference is made to the above description of FIGS. 2 and 3 for details thereof.

According to FIG. 4, the thus depicted apparatus according to exemplary embodiments of the present invention comprises a processor and a transceiver as well as, optionally, a memory.

The processor and the transceiver may be specifically configured to exchange, between the first policy decision point and the second policy decision point, supported policy control properties (including e.g. policy capabilities and/or status and/or load) of the first policy enforcement point and supported policy control properties (including e.g. policy capabilities and/or status and/or load) of the second policy enforcement point, thus individually and/or commonly representing means for exchanging policy control properties. Such exchange may be accomplished by sending and receiving corresponding information/data (as shown by messages 6 and 7 according to the exemplary procedures of FIGS. 2 and 3). In other words, the processor may have a corresponding exchange functionality.

The processor and the transceiver may also be specifically configured to acquire the supported policy control properties (including e.g. policy capabilities and/or status and/or load) of the first policy enforcement point, thus individually and/or commonly representing means for acquiring policy control properties. Such acquisition functionality may comprise at least one of a functionality of receiving supported policy control properties (including e.g. policy capabilities and/or status and/or load) from the first policy enforcement point upon control session establishment between the first policy decision point and the first policy enforcement point, and/or a functionality of informing supported policy control properties (including e.g. policy capabilities) upon pre-configuration, and/or a functionality of informing supported policy control properties (including e.g. status and/or load, such as a status change of the respective policy enforcement point).

In accordance with the exemplary implementation according to FIG. 2, the processor may be specifically configured to decide which one or ones of the policy control properties being supported by the first policy enforcement point is or are to be activated at the first policy enforcement point and/or to decide which one of the first and second policy enforcement points is to activate the one or ones of the policy control properties being supported by both of the first and second policy enforcement points, thus representing means for deciding. Such decisions may, for example, also be based on a priority of the first policy enforcement point, with respect to the second policy enforcement point, for certain one or ones of policy control properties being supported by both of the first and second policy enforcement points. In such case, the processor and the transceiver may also be specifically configured to request the first policy enforcement point to activate the supported policy control properties decided to be activated at the first policy enforcement point, thus individually and/or commonly representing means for requesting policy control activation. In other words, the processor may have a corresponding decision/request functionality.

In accordance with the exemplary implementation according to FIG. 3, the processor and the transceiver may be specifically configured to forward the supported policy control properties (including e.g. policy capabilities and/or status and/or load) of the second policy enforcement point to the first policy enforcement point, thus individually and/or commonly representing means for forwarding policy control properties (including e.g. policy capabilities and/or status and/or load). In other words, the processor may have a corresponding forwarding functionality.

The memory may be specifically configured to store any data required for and/or resulting from the above-described functionalities. For example, the memory may store received information regarding supported policy control properties (including e.g. policy capabilities and/or status and/or load) of the first and/or second policy enforcement points, and the like.

According to exemplarily embodiments of the present invention, a system may comprise any conceivable combination of the thus depicted apparatuses (such as one or more terminals and associated one or more base stations).

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

Generally, for the purpose of the present invention as described herein above, it should be noted that
method steps and functions likely to be implemented as software code portions and being run using a processor at one of the entities, a network element, or a terminal (as examples of devices, apparatuses and/or modules thereof, or as examples of entities including apparatuses and/or modules therefor), are software code independent and can be specified using any known or future developed programming language, such as e.g. Java, C++, C, and Assembler, as long as the functionality defined by the method steps is preserved;
generally, any method step is suitable to be implemented as software or by hardware without changing the idea of the invention in terms of the functionality implemented;
method steps, functions, and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for policy control interworking, such as for example for policy control interworking between mobile networks and fixed broadband networks, said measures exemplarily comprising exchanging, between a first policy decision point and a second policy decision point, supported policy control properties of a first policy enforcement point under control of the first policy decision point and supported policy control properties of a second policy enforcement point under control of the second policy decision point. An activation of one or more of supported policy control properties is essentially based on a consideration of both supported policy control properties of the first and the second policy enforcement points.

By virtue of embodiment of the present invention, as outlined above, vendors and operators of mobile (packet switched) and (fixed) broadband infrastructure, that are planning to support interworking between mobile and (fixed) broadband networks, may benefit. Policy enforcement points (PEPs) operating on the user plane of the same user session, but in networks possibly operated by different operators, may automatically be instructed, or may agree on, which features or capabilities should be activated and which deactivated in each PEP. Overlapping functionalities may be automatically kept unactivated or switched off on the fly, which may further improve the performance of the related network elements. Dynamic load balancing/sharing may be applied between the related network elements, based on how much there is processing intensive activity such as deep packet inspection activity in the access network.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

1. A method comprising
exchanging, between a first policy decision point and a second policy decision point, supported policy control properties of a first policy enforcement point under control of the first policy decision point and supported policy control properties of a second policy enforcement point under control of the second policy decision point.

2. The method according to claim 1, further comprising
acquiring the supported policy control properties of the first policy enforcement point,
said acquiring comprising at least one of
receiving the supported policy control properties from the first policy enforcement point upon control session establishment between the first policy decision point and the first policy enforcement point, and
informing the supported policy control properties upon pre-configuration.

3. The method according to claim 1, further comprising
deciding which one or ones of the policy control properties being supported by the first policy enforcement point is or are to be activated at the first policy enforcement point.

4. The method according to claim 3, further comprising
deciding, at either one of the first and second policy decision points, which one of the first and second policy enforcement points is to activate the one or ones of the policy control properties being supported by both of the first and second policy enforcement points.

5. The method according to claim 3, wherein said deciding is based on the supported policy control properties of the first and second policy enforcement points.

6. The method according to claim 3, wherein said deciding is based on at least one of
a pre-arrangement in terms of a user for which policy control is to be applied, and
an indication being exchanged between the first and second policy decision points.

7. The method according to claim 3, wherein
said deciding is based on a priority of one of the first and second policy enforcement points, with respect to the other one of the first and second policy enforcement point, for certain one or ones of policy control properties being supported by both of the first and second policy enforcement points, and
said priority is pre-configured and/or included in the exchange of policy control properties.

8. The method according to claim 3, further comprising
requesting the first policy enforcement point to activate the supported policy control properties decided to be activated at the first policy enforcement point.

9. The method according to claim 1, further comprising
forwarding, to the first policy enforcement point, the supported policy control properties of the second policy enforcement point.

10. The method according to claim 1, wherein the supported policy control properties comprise at least one of
policy control-related capabilities, such as policy enforcement capabilities and/or volume reporting capabilities and/or charging control capabilities,
status-related information, such as loading status and/or performance status,
preferences of activation of supported policy control properties, and
non-/support and/or extent of non-/support of policy control properties by the respective policy enforcement point and/or another entity.

11. The method according to claim 1, wherein
the method is operable at the first policy decision point, and/or
the first and second policy decision points communicate with each other via a S9* interface, and/or
the first/second policy decision function and the first/second policy enforcement function communicate with each other via a Gx interface, and/or
the first and second policy decision points and/or the first and second policy enforcement points are in accordance with different standards and/or are located in different networks, and/or
the first policy decision point comprises a 3GPP-based policy decision point and the second policy decision point comprises a BBF-based policy decision point, or vice versa, and/or
the first policy enforcement point comprises a 3GPP-based policy enforcement point, such as a policy and charging enforcement function, and the second policy enforcement point comprises a BBF-based policy enforcement point, such as traffic detection function, or vice versa.

12. A method comprising
receiving, at a first policy enforcement point under control of a first policy decision point, policy control information from the first policy decision point, and
activating one or ones of supported policy control properties of the first policy enforcement point in accordance with the received policy control information.

13. The method according to claim 12, further comprising
sending the supported policy control properties of the first policy enforcement point to the first policy decision point upon control session establishment between the first policy decision point and the first policy enforcement point.

14. The method according to claim 12, wherein
the received policy control information comprises a request for activation and an indication of the one or ones of the supported policy control properties to be activated at the first policy enforcement point.

15. The method according to claim 12, wherein
the received policy control information comprises supported policy control properties of a second policy enforcement point under control of a second policy enforcement function.

16. The method according to claim 15, further comprising
deciding which one or ones of the supported policy control properties is or are to be activated at the first policy enforcement point, wherein
said activating is based on the supported policy control properties decided to be activated at the first policy enforcement point.

17. The method according to claim 16, wherein
said deciding is based on a priority of the first policy enforcement point, with respect to the second policy enforcement point, for certain one or ones of policy control properties being supported by both of the first and second policy enforcement points, and
said priority is pre-configured and/or included in the received policy control information.

18. The method according to claim 12, wherein the supported policy control properties comprise at least one of
policy control-related capabilities, such as policy enforcement capabilities and/or volume reporting capabilities and/or charging control capabilities,
status-related information, such as loading status and/or performance status,
preferences of activation of supported policy control properties, and
non-/support and/or extent of non-/support of policy control properties by the respective policy enforcement point and/or another entity.

19. The method according to claim 12, wherein
the method is operable at the first policy enforcement point, and/or
the first and second policy decision points communicate with each other via a S9* interface, and/or
the first/second policy decision function and the first/second policy enforcement function communicate with each other via a Gx interface, and/or
the first and second policy decision points and/or the first and second policy enforcement points are in accordance with different standards and/or are located in different networks, and/or
the first policy decision point comprises a 3GPP-based policy decision point and the second policy decision point comprises a BBF-based policy decision point, or vice versa, and/or
the first policy enforcement point comprises a 3GPP-based policy enforcement point, such as a policy and charging enforcement function, and the second policy enforcement point comprises a BBF-based policy enforcement point, such as traffic detection function, or vice versa.

20. An apparatus comprising
a processor and a transceiver configured to
exchange, between a first policy decision point and a second policy decision point, supported policy control properties of a first policy enforcement point under control of the first policy decision point and supported policy control properties of a second policy enforcement point under control of the second policy decision point.

21. The apparatus according to claim 20, wherein the processor and the transceiver are further configured to
acquire the supported policy control properties of the first policy enforcement point,
said acquiring comprising at least one of receiving the supported policy control properties from the first policy
enforcement point upon control session establishment between the first policy decision point and the first policy enforcement point, and
informing the supported policy control properties upon pre-configuration.

22. The apparatus according to claim 20, the processor is further configured to
decide one or ones of the policy control properties being supported by the first policy enforcement point is or are to be activated at the first policy enforcement point.

23. The apparatus according to claim 22, the processor is further configured to
decide, at either one of the first and second policy decision points, which one of the first and second policy enforcement points is to activate the one or ones of the policy control properties being supported by both of the first and second policy enforcement points.

24. The apparatus according to claim 22, wherein the processor is configured to decide based on the supported policy control properties of the first and second policy enforcement points.

25. The apparatus according to claim 22, wherein the processor is further configured to decide based on at least one of
a pre-arrangement in terms of a user for which policy control is to be applied, and
an indication being exchanged between the first and second policy decision points.

26. The apparatus according to claim 22, wherein
the processor is further configured to decide based on a priority of one of the first and second policy enforcement points, with respect to the other one of the first and second policy enforcement point, for certain one or ones of policy control properties being supported by both of the first and second policy enforcement points, and
said priority is pre-configured and/or included in the exchange of policy control properties.

27. The apparatus according to claim 22, wherein the processor and the transceiver are further configured to
request the first policy enforcement point to activate the supported policy control properties decided to be activated at the first policy enforcement point.

28. The apparatus according to claim 20, wherein the processor and the transceiver are further configured to
forward, to the first policy enforcement point, the supported policy control properties of the second policy enforcement point.

29. The apparatus according to claim 20, wherein the supported policy control properties comprise at least one of
policy control-related capabilities, such as policy enforcement capabilities and/or volume reporting capabilities and/or charging control capabilities,
status-related information, such as loading status and/or performance status,
preferences of activation of supported policy control properties, and
non-/support and/or extent of non-/support of policy control properties by the respective policy enforcement point and/or another entity.

30. The apparatus according to claim 20, wherein
the apparatus is operable as or at the first policy decision point, and/or
the first and second policy decision points communicate with each other via a S9* interface, and/or
the first/second policy decision function and the first/second policy enforcement function communicate with each other via a Gx interface, and/or
the first and second policy decision points and/or the first and second policy enforcement points are in accordance with different standards and/or are located in different networks, and/or
the first policy decision point comprises a 3GPP-based policy decision point and the second policy decision point comprises a BBF-based policy decision point, or vice versa, and/or
the first policy enforcement point comprises a 3GPP-based policy enforcement point, such as a policy and charging enforcement function, and the second policy enforcement point comprises a BBF-based policy enforcement point, such as traffic detection function, or vice versa.

31. An apparatus comprising
a transceiver configured to receive, at a first policy enforcement point under control of a first policy decision point, policy control information from the first policy decision point, and
a processor configured to activate one or ones of supported policy control properties of the first policy enforcement point in accordance with the received policy control information.

32. The apparatus according to claim 31, wherein
the transceiver is further configured to send the supported policy control properties of the first policy enforcement point to the first policy decision point upon control session establishment between the first policy decision point and the first policy enforcement point.

33. The apparatus according to claim 31, wherein
the received policy control information comprises a request for activation and an indication of the one or ones of the supported policy control properties to be activated at the first policy enforcement point.

34. The apparatus according to claim 31, wherein
the received policy control information comprises supported policy control properties of a second policy enforcement point under control of a second policy enforcement function.

35. The apparatus according to claim 34, wherein the processor is further configured to
decide which one or ones of the supported policy control properties is or are to be activated at the first policy enforcement point, wherein
the processor is configured to activate based on the supported policy control properties decided to be activated at the first policy enforcement point.

36. The apparatus according to claim 35, wherein
the processor is configured to decide based on a priority of the first policy enforcement point, with respect to the second policy enforcement point, for certain one or ones of policy control properties being supported by both of the first and second policy enforcement points, and
said priority is pre-configured and/or included in the received policy control information.

37. The apparatus according to claim 31, wherein the supported policy control properties comprise at least one of
policy control-related capabilities, such as policy enforcement capabilities and/or volume reporting capabilities and/or charging control capabilities,
status-related information, such as loading status and/or performance status,
preferences of activation of supported policy control properties, and
non-/support and/or extent of non-/support of policy control properties by the respective policy enforcement point and/or another entity.

38. The apparatus according to claim 31, wherein
the apparatus is operable as or at the first policy enforcement point, and/or
the first and second policy decision points communicate with each other via a S9* interface, and/or
the first/second policy decision function and the first/second policy enforcement function communicate with each other via a Gx interface, and/or
the first and second policy decision points and/or the first and second policy enforcement points are in accordance with different standards and/or are located in different networks, and/or
the first policy decision point comprises a 3GPP-based policy decision point and the second policy decision point comprises a BBF-based policy decision point, or vice versa, and/or
the first policy enforcement point comprises a 3GPP-based policy enforcement point, such as a policy and charging enforcement function, and the second policy enforcement point comprises a BBF-based policy enforcement point, such as traffic detection function, or vice versa.

39. A computer program product including a program comprising software code portions being arranged, when run on a processor of an apparatus, to perform the method according to claim 1.

40. A computer program product including a program comprising software code portions being arranged, when run on a processor of an apparatus, to perform the method according to claim 12.
